(19) United States
(12) Patent Application Publication
(10) Pub. No.: US 2020/0292800 A1
(43) Pub. Date: Sep. 17, 2020

(54) OPTICAL DEVICE

(71) Applicant: TOYOTA JIDOSHA KABUSHIKI KAISHA, Toyota-shi (JP)

(72) Inventor: Mayu TAKAGI, Toyota-shi (JP)

(21) Appl. No.: 16/799,385

(22) Filed: Feb. 24, 2020

(30) Foreign Application Priority Data
Mar. 14, 2019 (JP) 2019-047407

(51) Int. Cl. G02B 17/08

(52) U.S. Cl. CPC G02B 17/0848; G02B 17/086

(57) ABSTRACT

Provided is an optical device that involves a simple attachment operation without the need for an adjustment process. The optical device includes a transparent body portion having a plurality of curved faces on its outer peripheral surface; and a blind-spot-side outward facing curved reflecting mirror, a blind-spot-side inward facing curved reflecting mirror, an eve-point-side inward facing curved reflecting mirror, and an eye-point-side outward facing curved reflecting mirror, which are integrally formed with the body portion. The body portion has formed therein an optical path that allows a light beam reflected by the blind-spot-side outward facing curved reflecting mirror to be sequentially reflected by the blind-spot-side inward facing curved reflecting mirror and the eye-point-side inward facing curved reflecting minor and then reach the eye-point-side outward facing curved reflecting mirror.

### CROSS REFERENCE TO RELATED APPLICATIONS

The present application claims priority from Japanese patent application JP 2019-047407 filed on Mar. 14, 2019, the entire content of which is hereby incorporated by reference into this application.

### BACKGROUND

### Technical Field

The present disclosure relates to an optical device for assisting in improving the visibility of an image of a blind spot that is obstructed by a shield.

### Background Art

Conventionally, as a technique of such a field, for example, a technique disclosed in JP 2018-127196 A is known. Specifically, JP 2018-127196 A discloses an optical device for allowing one to see an object that is obstructed by a shield, by reflecting or refracting a light beam from the obstructed object so as to avoid the shield using a plurality of reflecting mirrors and lenses.

### SUMMARY

However, since the plurality of reflecting mirrors and lenses are provided on separate members in the aforementioned optical device, it would be necessary to adjust the relative positions of the reflecting mirrors and the lenses when attaching the optical device to the shield, which is problematic in that the attachment operation becomes complex.

Accordingly, exemplary embodiments relate to providing an optical device that involves a simple attachment operation without the need for an adjustment process.

An optical device according to the present disclosure is an optical device for projecting an image of a blind spot in which a line of sight of a viewer is blocked by a shield, the optical device including a first light guide portion disposed on the shield on the blind spot side of the line of sight, the first light guide portion being adapted to guide an incident light beam coming from the blind spot side in a direction intersecting the line of sight; a reflective portion disposed facing the shield, the reflective portion being adapted to reflect the light beam guided by the first light guiding portion; and a second light guide portion disposed on the shield on an eye point side of the line of sight, the second light guide portion being adapted to guide the light beam reflected by the reflective portion to the eye point side of the line of sight, in which the first light guide portion, the reflective portion, and the second light guide portion are provided on a single transparent member, and the transparent member has formed therein an optical path that is adapted to allow a light beam guided by the first light guide portion to be reflected by the reflective portion and then reach the second light guide portion.

In the optical device according to the present disclosure, since the first light guide portion, the reflective portion, and the second light guide portion are provided on a single transparent member, and since the transparent member has formed therein an optical path that is adapted to allow a light beam guided by the first light guide portion to be reflected by the reflective portion and then reach the second light guide portion, the optical path is defined. Therefore, since it is not necessary to adjust the relative positions of reflecting mirrors and lenses as in the conventional optical device, an attachment operation for the optical device can be easily performed without the need for an adjustment process.

In the optical device according to the present disclosure, the first light guide portion may be formed of a first curved reflecting mirror that is adapted to reflect an incident light beam coming from the blind spot side to the reflective portion, and the second light guide portion may be formed of a second curved reflecting mirror that is adapted to reflect a light beam reflected by the reflective portion to the eye point side of the line of sight. Accordingly, an image of a blind spot can be projected even when the optical device is tilted in the front-rear direction as seen from the eye point.

In the optical device according to the present disclosure, the first light guide portion may be formed of a first lens that is adapted to refract an incident light beam coming from the blind spot side toward the reflective portion, and the second light guide portion may be formed of a second lens that is adapted to refract a light beam reflected by the reflective portion and output the light beam to the eye point side of the line of sight. Accordingly, an image of a blind spot can be projected even when the optical device is tilted in the left-right direction as seen from the eye point.

In the optical device according to the present disclosure, each of the first curved reflecting mirror and the second curved reflecting mirror may be formed by vapor-depositing a metal film on the transparent member. Accordingly, the first curved reflecting mirror and the second curved reflecting mirror can be easily formed.

According to the present disclosure, an attachment operation for an optical device can be easily performed without the need for an adjustment process.

### BRIEF DESCRIPTION OF THE DRAWINGS

FIG. 1 is a plan view illustrating an overview of an optical device according to the first embodiment;

FIG. 2A is a plan view illustrating the invisible region of the optical device according to the first embodiment;

FIG. 2B is a plan view illustrating the invisible region of an optical device according to a comparative example;

FIG. 3A illustrates the angle of incidence and the angle of refraction of a light beam when it becomes incident on the body portion from the air;

FIG. 3B illustrates the angle of incidence and the angle of refraction of a light beam when it enters the air from the body portion;

FIG. 4 is a plan view illustrating an overview of an optical device according to the second embodiment;

FIG. 5A is a view illustrating a state in which a light beam in parallel with a line of sight of a viewer and an obliquely incident light beam are allowed to become incident on the optical device according to the second embodiment;

FIG. 5B is a view illustrating a state in which a parallel light beam in parallel with a line of sight of a viewer and an obliquely incident light beam are allowed to become incident on an optical device according to a comparative example;

FIG. 6A is a view for explaining the visible region of the optical device according to the second embodiment; and

FIG. 6B is a view for explaining the visible region of the optical device according to the comparative example.

### DETAILED DESCRIPTION

Hereinafter, embodiments of an optical device according to the present disclosure will be described with reference to the drawings. In the description of the drawings, the same elements are denoted by the same reference numerals, and repetitive descriptions thereof are omitted.

### First Embodiment

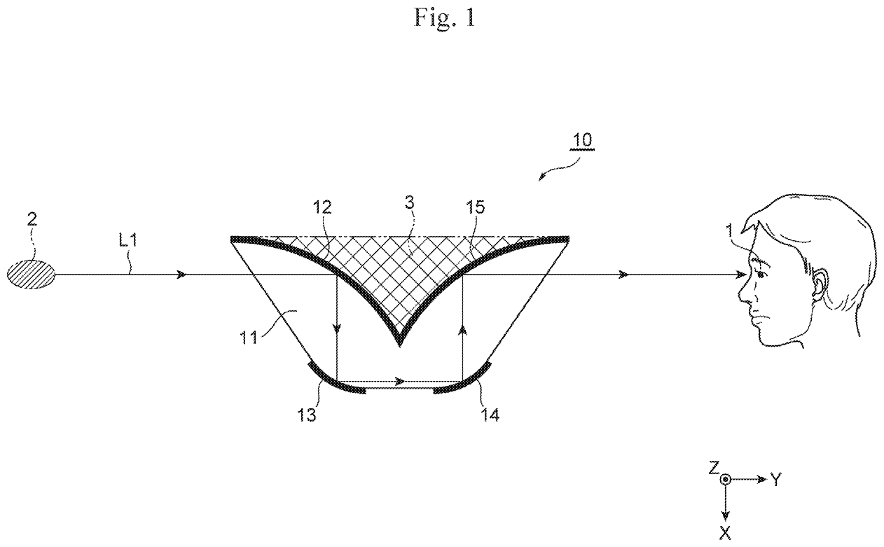

FIG. 1 is a plan view illustrating an overview of an optical device according to the first embodiment. An optical device 10 according to the present embodiment is adapted to be attached to a shield 3, such as an A-pillar, of an automobile, for example, so as to assist in improving the visibility of an image of a blind spot that is obstructed by the shield 3.

More specifically, a viewer, such as a driver, of an automobile can directly see a scene outside the vehicle through the windshield and the side glass, but the line of sight of the viewer is obstructed by the shield 3, such as the A-pillar. Thus, a blind spot, which is a region not directly visible to the viewer, is generated. The optical device 10 of the present embodiment is configured to make the shield 3, such as an A-pillar, appear transparent, and project an image of a blind spot at the same position as when the shield 3 is not present, so as to assist in helping the viewer see an object 2 that is present in the blind spot. Herein, the phrase “to make something appear transparent” means making something, which is present, appear as if it is not present, and means a state in which the background is visible without being hidden by a shield.

To help easy understanding of the configuration of the optical device 10, in the following description, it is assumed that an axis lying along the direction in which the shield 3 is seen from the eye point 1 of the viewer (i.e., a line of sight) is the Y-axis, an axis lying along the direction in which the shield 3, such as the A-pillar, extends is the Z-axis, and an axis that is orthogonal to the Y-axis and the Z-axis is the X-axis. In addition, a direction in which each of the arrows indicating the X-axis, the Y-axis, and the Z-axis is pointing is defined as the positive direction of each axis, and a direction opposite thereto is defined as the negative direction of each axis. in such a case, the positive direction of the Y-axis indicates a direction toward the eye point 1 from the shield 3, and the positive direction of the Z-axis indicates a direction toward the vehicle body roof from the vehicle body floor of the automobile along the shield 3, such as the A-pillar.

As illustrated in FIG. 1, the optical device 10 includes a transparent body portion (i.e., transparent member) 11 having a plurality of curved faces on its outer peripheral surface; and a blind-spot-side outward facing curved reflecting mirror 12, a blind-spot-side inward facing curved reflecting mirror 13, an eye-point-side inward facing curved reflecting mirror 14, and an eye-point-side outward facing curved reflecting mirror 15, which are formed integrally with the body portion 11.

The body portion 11 is integrally formed using transparent glass or transparent resin, for example. Examples of the resin material include acrylic, polyethylene terephthalate, polycarbonate, and polyethylene, which are translucent and have low light absorption and low light scattering.

The blind-spot-side outward facing curved reflecting mirror 12 is disposed on the shield 3 on the blind spot side of the line of sight (i.e., on the object 2 side), and reflects an incident light beam in the positive direction of the Y-axis coming from the blind spot side, in the positive direction of the X-axis that is a direction intersecting the line of sight and is away from the shield 3. The blind-spot-side outward facing curved reflecting mirror 12 is formed by vapor-depositing metal on a portion of the outer peripheral surface of the body portion 11 that curves toward the positive direction of the X-axis, for example. The blind-spot-side outward facing curved reflecting mirror 12 corresponds to the “first curved reflecting mirror” recited in the claims, and forms the “first light guide portion” recited in the claims.

The blind-spot-side inward facing curved reflecting mirror 13 is disposed facing the blind-spot-side outward facing curved reflecting mirror 12, and reflects a light beam in the positive direction of the X-axis, which has been reflected by the blind-spot-side outward facing curved reflecting minor 12, in the positive direction of the Y-axis toward the eye point 1. The blind-spot-side inward facing curved reflecting mirror 13 is formed by vapor-depositing metal on a portion of the outer peripheral surface of the body portion 11 that curves toward the negative direction of the X-axis and faces the blind-spot-side outward facing curved reflecting mirror 12. for example.

The eye-point-side inward facing curved reflecting mirror 14 is disposed on the side closer to the eye point 1 than is the blind-spot-side inward facing curved reflecting mirror 13, and reflects a light beam in the positive direction of the Y-axis, which has been reflected by the blind-spot-side inward facing curved reflecting mirror 13, in the negative direction of the X-axis that is a direction intersecting the line of sight and approaching the shield 3. The eye-point-side inward facing curved reflecting mirror 14 is formed by vapor-depositing metal on a portion of the outer peripheral surface of the body portion 11 that curves toward the negative direction of the X-axis and faces the eye-point-side outward facing curved reflecting mirror 15. for example.

Each of the blind-spot-side inward facing curved reflecting mirror 13 and the eye-point-side inward facing curved reflecting mirror 14 corresponds to the “reflective portion” recited in the claims.

The eye-point-side outward facing curved reflecting mirror 15 is disposed on the shield 3 on the eye point 1 side of the line of sight (i.e., the viewer side) and facing the eye-point-side inward facing curved reflecting mirror 14, and reflects a light beam in the negative direction of the X-axis, which has been reflected by the eye-point-side inward facing curved reflecting mirror 14, in the positive direction of the Y-axis toward the eye point 1 side of the line of sight. The eye-point-side outward facing curved reflecting mirror 15 is formed by vapor-depositing metal on a portion of the outer peripheral surface of the body portion 11 that curves toward the positive direction of the X-axis and faces the eye-point-side inward facing curved reflecting mirror 14, for example. The eye-point-side outward facing curved reflecting mirror 15 corresponds to the “second curved reflecting mirror” recited in the claims, and forms the “second light guide portion” recited in the claims.

As illustrated in FIG. 1, the blind-spot-side outward facing curved reflecting mirror 12 and the eye-point-side outward facing curved reflecting minor 15 are coupled together around the central axis of the optical device 10 so as to form a substantial V-shape. The optical device 10 is fixed to the shield 3 with an adhesive, for example, in a state in which the shield 3 is disposed so as to enter a V-shaped space formed by the blind-spot-side outward facing curved surface reflector 12 and the eye-point-side outward facing curved surface reflector 15.

According to such a configuration, the optical device 10 reflects an incident light beam L1, which comes from the blind spot side, in the positive direction of the X-axis using the blind-spot-side outward facing curved reflecting minor 12, reflects the incident light beam L1 in the positive direction of the Y-axis using the blind-spot-side inward facing curved reflecting mirror 13, and further reflects the incident light beam L1 in the negative direction of the X-axis using the eye-point-side inward facing curved reflecting mirror 14, and then reflects the incident light beam L1 in the positive direction of the Y-axis using the eye-point-side outward facing curved reflecting mirror 15. Therefore, the incident light beam L1 coming from the blind spot side is output toward the eye point 1 so that an image of the blind spot can be projected at the position of the shield 3 as seen from the eye point 1. Accordingly, the line of sight of the viewer is not obstructed by the shield 3, and the shield 3 can thus be made to appear transparent. This allows the viewer to see the object 2 on the other side of the shield 3 and thus can assist in improving the visibility of the image of the blind spot to the viewer.

In the present embodiment, the body portion 11 has formed therein an optical path that allows a light beam reflected by the blind-spot-side outward facing curved reflecting mirror 12 to be sequentially reflected by the blind-spot-side inward facing curved reflecting mirror 13 and the eye-point-side inward facing curved reflecting mirror 14 and then reach the eye-point-side outward facing curved reflecting mirror 15.

In the optical device 10 according to the present embodiment, since the blind-spot-side outward facing curved reflecting mirror 12, the blind-spot-side inward facing curved reflecting mirror 13, the eye-point-side inward facing curved reflecting mirror 14, and the eye-point-side outward facing curved reflecting mirror 15 are provided on the body portion 11, which is a single transparent member, and since the body portion 11 has formed therein the optical path, which allows a light beam reflected by the blind-spot-side outward facing curved reflecting mirror 12 to be sequentially reflected by the blind-spot-side inward facing curved reflecting mirror 13 and the eye-point-side inward facing curved reflecting mirror 14 and then reach the eye-point-side outward facing curved reflecting mirror 15, the optical path is defined. Therefore, since it is not necessary to adjust the relative positions of reflecting mirrors and lenses as in the conventional optical device, an attachment operation for the optical device 10 can be easily performed without the need for an adjustment process.

In addition, since the blind-spot-side outward facing curved reflecting mirror 12, the blind-spot-side inward facing curved reflecting mirror 13, the eye-point-side inward facing curved reflecting mirror 14, and the eye-point-side outward facing curved reflecting mirror 15 are provided on the body portion 11, which is a single transparent member, the size of the optical device 10 as well as the invisible region of the optical device 10 can be reduced as compared to when such curved reflecting mirrors are provided on separate members.

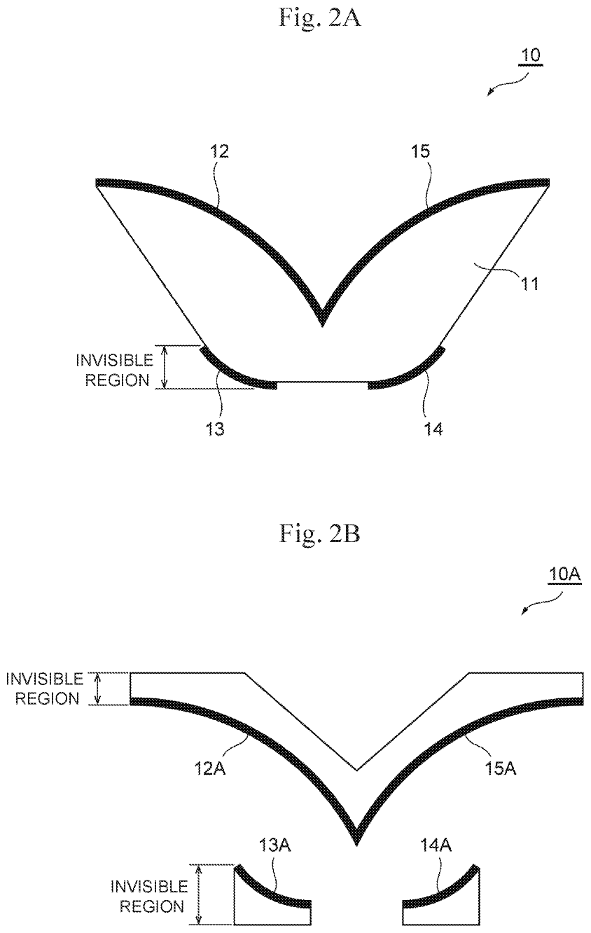

More specifically, for example, an optical device 10A according to a comparative example illustrated in FIG. 2B includes a blind-spot-side outward facing curved reflecting mirror 12A, a blind-spot-side inward facing curved reflecting mirror 13A, an eye-point-side inward facing curved reflecting mirror 14A, and an eye-point-side outward facing curved reflecting mirror 15A, similarly to the aforementioned optical device 10. In addition, the blind-spot-side outward facing curved reflecting mirror 12A and the eye-point-side outward facing curved reflecting mirror 15A are provided on a single member.

Meanwhile, the blind-spot-side inward facing curved reflecting mirror 13A and the eye-point-side inward facing curved reflecting mirror 14A are provided on members different from the transparent member on which the blind-spot-side outward facing curved reflecting mirror 12A and the eye-point-side outward facing curved reflecting mirror 15A are provided. That is, the optical device 10A according to the comparative example includes three members. Therefore, attachment of the optical device according to the comparative example to an A-pillar of a vehicle, for example, involves the operations of individually fixing the three members to the A-pillar.

In contrast, since the optical device 10 according to the present embodiment is provided on a single transparent member (i.e., body portion 11) as described above, the size of the optical device 10 can be reduced as compared to that of the optical device 10A according to the comparative example. Further, since the attachment operation for the optical device 10 can be completed only by fixing the body portion 11 to the shield 3, such as an A-pillar of a vehicle, the attachment operation can be simplified as compared to that for the optical device 10A according to the comparative example.

Further, in the comparative example illustrated in FIG. 2B, each curved reflecting mirror of the optical device 10A should have a certain thickness to secure a certain strength of each curved reflecting mirror, which results in an increased invisible region. In contrast, in the optical device 10 according to the present embodiment, only the region in which the blind-spot-side inward facing curved reflecting mirror 13 and the eye-point-side inward facing curved reflecting mirror 14 are provided is the invisible region (see FIG. 24). Thus, the invisible region of the optical device 10 can be reduced as compared to that of the optical device 10A according to the comparative example.

Further, since the optical device 10 according to the present embodiment includes the blind-spot-side outward facing curved reflecting mirror 12, which reflects an incident light beam coming from the blind spot side to the blind-spot-side inward facing curved reflecting mirror 13, and the eye-point-side outward facing curved reflecting mirror 15, which reflects a light beam reflected by the eve-point-side inward facing curved reflecting mirror 14 to the eye point side of the line of sight, an image of the blind spot can be projected even when the optical device 10 is tilted in the front-rear direction as seen from the eye point. For example, when an A-pillar is disposed in a tilted state on the vehicle cabin side of the vehicle, an image of a blind spot can be projected even if the optical device 10 is fixed to the A-pillar in a tilted state in the front-rear direction along the tilt of the A-pillar.

Further, since each of the blind-spot-side outward facing curved reflecting mirror 12, the blind-spot-side inward facing curved reflecting mirror 13, the eye-point-side inward facing curved reflecting mirror 14, and the eye-point-side outward facing curved reflecting mirror 15 is formed by vapor-depositing a metal film on a transparent member, such curved reflecting mirror can be easily formed.

It should be noted that the shape of the body portion 11 of the optical device 10 is not particularly limited as long as it does not totally reflect an incident light beam coming from the blind spot side or a light beam that has been reflected by the eye-point-side outward facing curved reflecting mirror 15 and travels toward the eye point side.

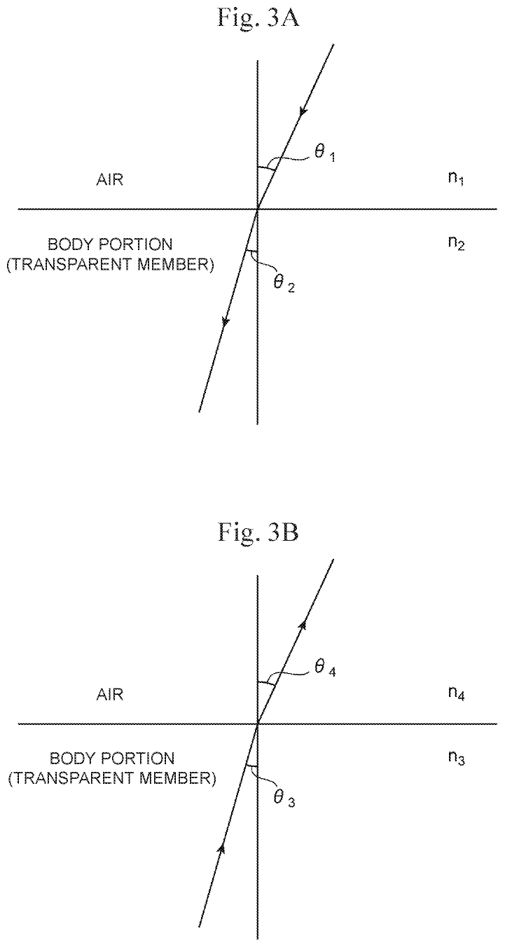

More specifically, as illustrated in FIG. 3A, when an incident light beam coming from the blind spot side travels from the air (having an refractive index of n₁) to the body portion 11 (i.e., the transparent member, having a refractive index of n₂) of the optical device 10, a relational expression n₁sinθ₁=n₂sinθ₂ is established between the angle of incidence θ₁ and the angle of refraction θ₂ according to the Snell's law. If the refractive index of the air is 1 (n₁=1) and the angle of refraction θ₂ is 90° (θ₂=90° ), an incident light beam will be totally reflected at the boundary between the air and the transparent member. Therefore, when the condition (sinθ₁/n₂)≥sin90° is satisfied, an incident light beam will be totally reflected at the boundary between the air and the transparent member. That is, as long as the condition (sinθ₁/n₂) <1 is satisfied, an incident light beam will not be totally reflected and will pass through the boundary between the air and the transparent member.

Meanwhile, as illustrated in the FIG. 3B, when a light beam, which has been reflected by the eye-point-side outward facing curved reflecting mirror 15 and travels toward the eye point side (hereinafter simply referred to as an “outgoing light beam”), travels from the body portion(i.e., the transparent member, having a refractive index of n₃) to the air (having a refractive index of n₄), a relational expression n₃sinθ₃=n₄sinθ₄ is established between the angle of incidence θ₃ and the angle of refraction θ₄ according to Snell's law. If the refractive index of the air is 1 (n₄=1) and the angle of refraction θ₄ is 90° (θ₄=90° ), an outgoing light beam will be totally reflected at the boundary between the transparent member and the air. Therefore, when the condition (n₃sinθ₃/n₄)≥sin90° is satisfied, an outgoing light beam will be totally reflected at the boundary between the transparent member and the air. That is, as long as the condition (n₃sinθ₃) <1 is satisfied, an outgoing light beam will not be totally reflected and will pass through the boundary between the transparent member and the air.

Therefore, various modifications may be made to the shape of the body portion 11 of the optical devices 10 as long as the condition (sinθ₁/n₂) <1 and (n₃sin θ₃) <1 is satisfied because total reflections of an incident light beam and an outgoing light beam will not occur under such condition.

### Second Embodiment

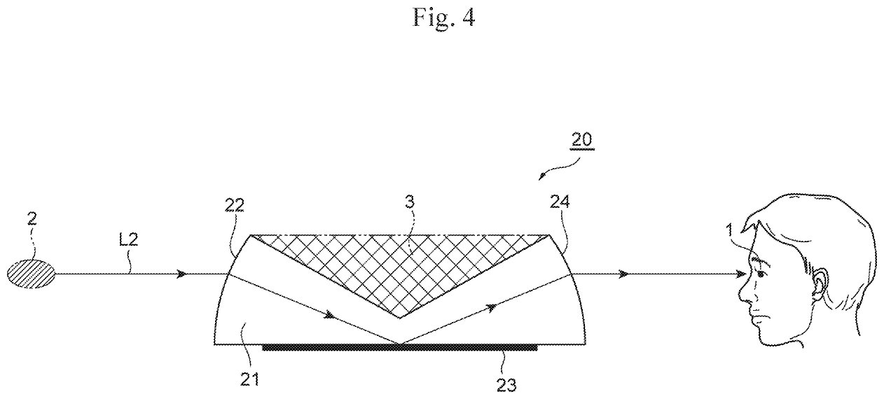

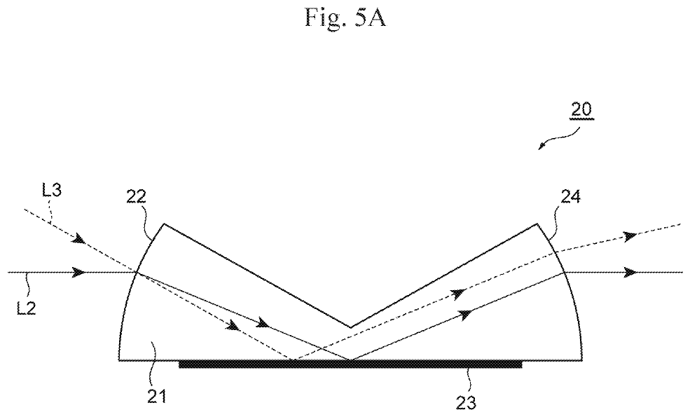

FIG. 4 is a plan view illustrating an overview of an optical device according to the second embodiment. An optical device 20 according to the present embodiment differs from that of the aforementioned first embodiment in its structure.

As illustrated in FIG. 4, the optical device 20 according to the present embodiment includes a transparent body portion 21; and a first lens 22, a reflective portion 23, and a second lens 24, which are integrally formed with the body portion 21.

The body portion 21 has a cross-section with a V-shaped groove that is recessed toward the center of a semicircle from its outer circumference. The body portion 21 is integrally formed using transparent glass or transparent resin, for example. Examples of the resin material include acrylic, polyethylene terephthalate, polycarbonate, and polyethylene, which are translucent and have low light absorption and low light scattering.

The first lens 22 has a convex surface and is formed of a part of the body portion 21. That is, the first lens 22 is a part of the body portion 21 The first lens 22 is disposed on the shield 3 on the blind spot side of the line of sight, and refracts an incident light beam coining from the blind spot side toward the reflective portion 23. The first lens 22 forms the “first light guide portion” recited in the claims.

The reflective portion 23 is formed of a plane reflecting mirror, and is disposed facing the shield 3 so as to reflect a light beam from the first lens 22. The reflective portion 23 is formed by vapor-depositing metal on a portion of the flat outer peripheral surface of body portion 21 that faces the shield 3, for example.

The second lens 24 has a convex surface and is formed of a part of the body portion 21. That is, the second lens 24 is a part of the body portion 21. The second lens 24 is disposed on the shield 3 on the eye point 1 side of the line of sight, and refracts a light beam, which has been reflected by the reflective portion 23, toward the eye point 1 side. The second lens 24 forms the “second light guide portion” recited in the claims.

As illustrated in FIG. 4, the optical device 20 is fixed to the shield 3 with an adhesive, for example, in a state in which the shield 3 is disposed so as to enter a V-shaped groove formed in the body portion 21.

According to such a configuration, the optical device 20 refracts a parallel light beam L2, which is in parallel with the line of sight, out of incident light beams coming from the blind spot side, toward the reflective portion 23 using the first lens 22, reflects the parallel light beam L2 onto the second lens 24 using the reflective portion 23, and further refracts the parallel light beam L2 using the second lens 24, thereby outputting the parallel light beam L2 to the eve point 1 side. Therefore, the parallel light beam L2 coming from the blind spot side can be output to the eye point 1 side, and an image of the blind spot can be projected at the position of the shield 3 as seen from the eye point 1. Accordingly, the line of sight of the viewer is not obstructed by the shield 3, and the shield 3 can thus be made to appear transparent. This allows the viewer to see the object 2 on the other side of the shield 3 and thus can assist in improving the visibility of the image of the blind spot to the viewer.

In the present embodiment, the body portion 21 has formed therein an optical path, which allows a light beam having passed through the first lens 22 to be reflected by the reflective portion 23 and then reach the second lens 24.

In the optical device 20 according to the present embodiment, since the first lens 22, the reflective portion 23, and the second lens 24 are provided on the body portion 21, which is a. single transparent member, and since the body portion 21 has formed therein the optical path that allows a light beam having passed through the first lens 22 to be reflected by the reflective portion 23 and then reach the second lens 24, the optical path is defined. Therefore, since it is not necessary to adjust the relative positions of reflecting mirrors and lenses as in the conventional optical device, an attachment operation for the optical device 10 can be easily performed without the need for an adjustment process.

In addition, since the first lens 22, the reflective portion 23, and the second lens 24 are provided on the body portion 21, which is a single transparent member, the attachment operation for the optical device can be further simplified and the compatibility with an obliquely incident light beam can be increased as compared to when lenses and reflecting mirrors are provided on separate members, so that the range of the field of view of the viewer can be increased.

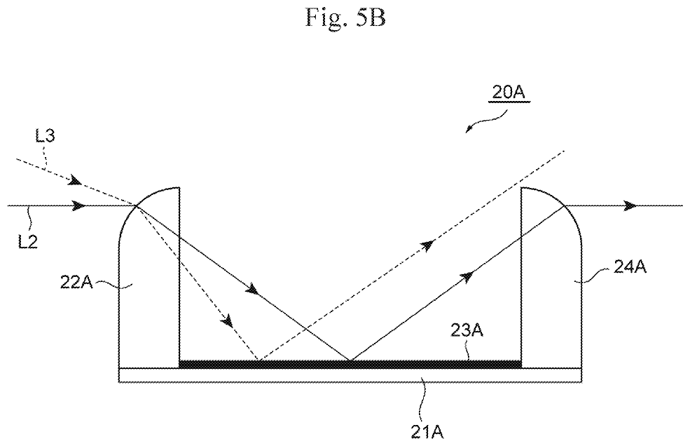

More specifically, for example, an optical device 20A according to a comparative example illustrated in FIG. 5B includes a first lens 22A, a reflective portion 23A, and a second lens 24A similarly to the aforementioned optical device 20, but the first lens 22A, the reflective portion 23A, and the second lens 24A are provided on separate members. The first lens 22A, the reflective portion 23A, and the second lens 24A are fixed to a single attachment member 21A, and are attached to an A-pillar of a vehicle, for example, via the attachment member 21A, Therefore, fixing the first lens 22A, the reflective portion 23A, and the second lens 24A to the attachment member 21A involves the operations of adjusting the positions of the respective components.

In contrast, since the optical device 20 according to the present embodiment is provided on a single transparent member as described above, the attachment operation for the optical device 20 can be completed only by fixing the transparent member to a target. Thus, the attachment operation can be simplified as compared to that for the optical device 20A according to the comparative example. In addition, since the attachment member 21A of the optical device 20A according to the comparative example can be omitted, the number of components can be reduced.

In the comparative example illustrated in FIG. 5B, when an obliquely incident light beam L3 intersecting the line of sight comes from the blind spot side, the obliquely incident light beam L3 may not reach the second lens 24A if it is refracted by the first lens 22A toward the reflective portion 23A, passes through the boundary between the first lens 22A and the air, and is further reflected by the reflective portion 23A. In such a case, since the obliquely incident light beam L3 does not reach the eye point 1 side, the range of the field of view of the viewer becomes narrow.

In contrast, in the optical device 20 according to the present embodiment, as illustrated in FIG. 5A, since an optical path, which allows a light beam having passed through the first lens 22 to be reflected by the reflective portion 23 and then reach the second lens 24, is formed inside the body portion 21, the boundary between the air and the transparent member can be reduced as compared to that of the optical device 20A according to the comparative example. Thus, the compatibility with an obliquely incident light beam can be increased. Consequently, the range of the field of view of the viewer can be increased as compared to that of the optical device 20A according to the comparative example. Therefore, an image of the blind spot can be projected even when the optical device 20 is tilted in the left-right direction as seen from the eye point.

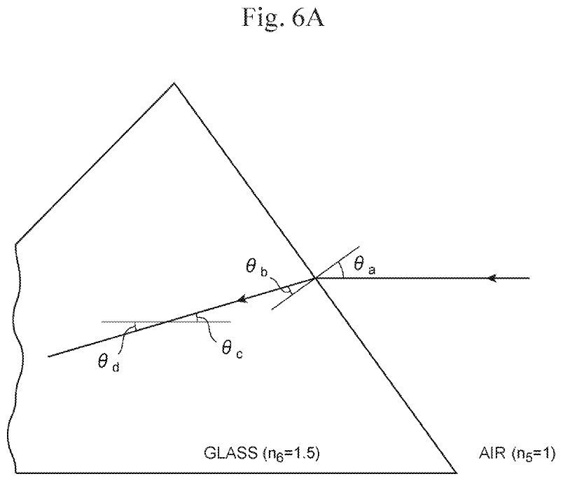

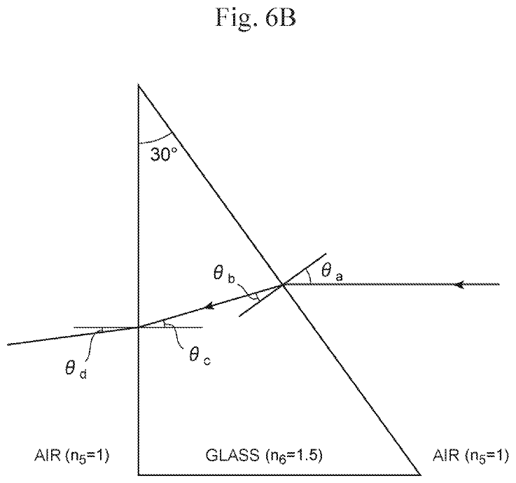

This will he described in detail with reference to FIGS. 6A and 6B. FIG. 6A illustrates the lens of the present disclosure, and FIG. 6B illustrates the lens of the comparative example. Each lens is approximated to a triangular prism. In FIGS. 6A and 6B, it is assumed that each lens is made of glass (having a refractive index of n₆=1.5), the angle θₐ of incidence of an incident light beam in parallel with the line of sight is 30°, and the angle θₐ of incidence of an obliquely incident light beam is 25°. In addition, symbols θ_{b}, θ_{c}, and θ_{d} indicate the angles of refraction, incidence, and emergence, respectively. Herein, the difference between the angle θ_{d} of an obliquely incident light beam and the angle θ_{d} of an incident light beam in parallel with the line of sight is determined on the basis of the Snell's Law, for example.

Table 1 shows the process of calculating the angle θ_{d} of an incident light beam in parallel with the line of sight for each of the lens of the present disclosure and the lens of the comparative example, and the angle θ_{d} of an obliquely incident light beam for each of the lens of the present disclosure and the lens the comparative example.

TABLE 11

| | | Lens of |
|---|---|---|
| | Lens of Present | Comparative |
| | Disclosure | Example |
| Angle of Incident Light | n₅sinθₐ = n₆sinθ_{b} | n₅sinθₐ = n₆sinθ_{b} |
| Beam in Parallel | 1sin30° = 1.5sinθ_{b} | 1sin30° = 1.5sinθ_{b} |
| with Line of Sight | θ_{b} = 19.4° | θ_{b} = 19.4° |
| θₐ = 30° | θ_{c} = θₐ − θ_{b} = 10.5° | θ_{c} = θₐ − θ_{b} = 10.5° |
| | θ_{d} = θ_{c} = 10.5° | n₆sinθ_{c} = n₅sinθ_{d} |
| | (because there | 1.5sin10.5° = 1sinθ_{d} |
| | is no boundary | θ_{d} = 15.8° |
| Angle of Obliquely | n₅sinθₐ = n₆sinθ_{b} | n₅sinθₐ = n₆sinθ_{b} |
| Incident Light Beam | 1sin25° = 1.5sinθ_{b} | 1sin25° = 1.5sinθ_{b} |
| θₐ = 25° | θ_{b} = 16.3° | θ_{b} = 16.3° |
| | θ_{c} = θₐ − θ_{b} = 13.6° | θ_{c} = θₐ − θ_{b} = 13.6° |
| | θ_{d} = θ_{c} = 13.6° | n₆sinθ_{c} = n₅sinθ_{d} |
| | (because there | 1.5sin13.6° = 1sinθ_{d} |
| | is no boundary | θ_{d} = 20.7° |
| Difference between θ_{d} of | 3.1° | 4.9° |
| Obliquely Incident Light | | |
| Beam and θ_{d} of Incident | | |
| Light Beam in parallel | | |
| with Line of Sight | | |

As shown in Table 1, regarding the lens of the comparative example, the difference between the angle θ_{d} of an obliquely incident light beam and the angle θ_{d} of an incident light beam in parallel with the line of sight is 4.9°. Meanwhile, regarding the lens of the present disclosure, the difference between the angle θ_{d} of an obliquely incident light beam and the angle θ_{d} of an incident light beam in parallel with the line of sight is 3.1°. This can confirm that the lens of the present disclosure is less likely to be influenced by an obliquely incident light, that is, the lens of the present disclosure has higher compatibility with an obliquely incident light beam. Therefore, the optical device 20 of the present embodiment can increase the range of the field of view of the viewer.

Although the embodiments of the present disclosure have been described in detail above, the present disclosure is not limited thereto, and various design modifications can be made without departing from the spirit or scope of the present disclosure recited in the claims.

For example, although the aforementioned first embodiment illustrates an example in which the blind-spot-side inward facing curved reflecting mirror 13 and the eye-point-side inward facing curved reflecting mirror 14 forming the reflective portion are formed separately, such mirrors may also be integrally formed such that they are coupled together.

### DESCRIPTION OF SYMBOLS

1 Eye point
2 Object
3 Shield
10, 20 Optical device
11, 21 Body portion (transparent member)
12 Blind-spot-side outward facing curved reflecting mirror (first curved reflecting mirror)
13 Blind-spot-side inward facing curved reflecting mirror (reflective portion)
14 Eye-point-side inward facing curved reflecting mirror (reflective portion)
15 Eye-point-side outward facing curved reflecting mirror (second curved reflecting mirror)
22

First lens (first light guide portion)
23 Reflective portion
24 Second lens (second light guide portion

What is claimed is:

1. An optical device for projecting an image of a blind spot in which a line of sight of a viewer is obstructed by a shield, comprising:
a first light guide portion disposed on the shield on the blind spot side of the line of sight, the first light guide portion being adapted to guide an incident light beam coming from the blind spot side in a direction intersecting the line of sight;
a reflective portion disposed facing the shield, the reflective portion being adapted to reflect the light beam guided by the first light guiding portion; and
a second light guide portion disposed on the shield on an eye point side of the line of sight, the second light guide portion being adapted to guide the light beam reflected by the reflective portion to the eye point side of the line of sight,
wherein:
the first light guide portion, the reflective portion, and the second light guide portion are provided on a single transparent member, and
the transparent member has formed therein an optical path that is adapted to allow a light beam guided by the first light guide portion to be reflected by the reflective portion and then reach the second light guide portion.

2. The optical device according to claim 1,
wherein:
the first light guide portion is formed of a first curved reflecting mirror that is adapted to reflect an incident light beam coming from the blind spot side to the reflective portion, and
the second light guide portion is formed of a second curved reflecting mirror that is adapted to reflect a light beam reflected by the reflective portion to the eve point side of the line of sight.

3. The optical device according to claim 1,
wherein:
the first light guide portion is formed of a first lens that is adapted to refract an incident light beam coming from the blind spot side toward the reflective portion, and
the second light guide portion is formed of a second lens that is adapted to refract a light beam reflected by the reflective portion and output the light beam to the eye point side of the line of sight.

4. The optical device according to claim 2, wherein each of the first curved reflecting mirror and the second curved reflecting mirror is formed by vapor-depositing a metal film on the transparent member.
